(19) United States
(12) Patent Application Publication
(10) Pub. No.: US 2003/0218627 A1
(43) Pub. Date: Nov. 27, 2003

(54) Outbound data traffic monitoring

(75) Inventors: Carl Phillip Gusler, Austin, TX (US); Rick Allen Hamilton II, Charlottesville, VA (US); Steven Jay Lipton, Flower Mound, TX (US); Timothy Moffett Waters, Richmond, VA (US)

Correspondence Address: Robert V. Wilder, Attorney at Law, 4235 Kingsburg Drive, Round Rock, TX, 78681, US

(73) Assignee: International Business Machines Corporation, Armonk, NY (US)

(21) Appl. No.: 10/156,783

(22) Filed: May 24, 2002

(51) Int. Cl. G09G 5/00

(52) U.S. Cl. 345/736

(57) ABSTRACT

A method and implementing computer system are provided for enabling a user to control the flow of data from the user computer system. Data scheduled for transmission from the user system are monitored and when a scheduled outbound flow of data is detected, a data control window or screen is presented to the user. The data control screen may be activated upon any detection of scheduled outbound data or only upon the detection of a predetermined string or sequences of data. The data control screen enables a user to review outbound data before it is transmitted and to selectively take various control actions relative to the data. In one embodiment, the data screen appears whenever a scheduled outbound data transfer request is detected. In another embodiment, the user is enabled to define predetermined specific data strings in a database, and the data screen does not appear unless one or more of the predetermined data strings has been detected in a scheduled outbound data transfer.

### FIELD OF THE INVENTION

The present invention relates generally to information processing systems and more particularly to a methodology and implementation for enabling selective control of outbound data from a computer system.

### BACKGROUND OF THE INVENTION

In today's society, information systems play a pervasive role in substantially all human activities. Computers and the Internet have revolutionized information exchange. However, this free flow of information has created new problems in the area of information security, privacy and the protection of personal data.

In many network applications, including Internet sessions, data files are created and stored on user systems without the user even being aware of the existence of such files. The creation and storage of such files is considered a means of improving system efficiency so that once a file, such as a so-called “cookie” is created and stored, the information within that file does not have to be retrieved from various user system locations the next time the user logs-on to a particular website for example. All of the information needed for the initial log-on and home page presentation is already assembled in one or more cookie files and the processing time is kept to a minimum. This system is quite helpful, for example, when a user logs-on to an Internet website and purchases goods while “on-line”. A user cookie may be created which contains the user name, address, phone numbers, credit card numbers, etc. All of this information is considered personal by the user and the user may not wish to have such information available to everyone without restriction. Nevertheless, such data files are created routinely and may be accessed by other websites and hackers to obtain and misuse the personal data contained therein. Further, in the past there was no way for the user to even be aware that personal information or data are being accessed and sent to another system requesting such information. In most cases the acquisition and sending of such data is accomplished “in the background” while running another application with a connected website.

Thus, there is a need for an improved computer system and methodology by which a user may exercise greater control over the access to and transfer of selected data present on a user system.

### SUMMARY OF THE INVENTION

A method and implementing computer system are provided for enabling a user to control the flow of data from the user computer system. Data scheduled for transmission from the user system are monitored and when a scheduled outbound flow of data is detected, a data control window or screen is presented to the user. The data control screen may be activated upon any detection of scheduled outbound data or only upon the detection of a predetermined string or sequences of data. The data control screen enables a user to review outbound data before it is transmitted and to selectively take various control actions relative to the data. For example, upon the detection and presentation of a string of user personal information which is being fetched by a connected website, the user may selectively disconnect from the connected website or authorize the sending of the displayed data on a case-by-case basis. A user may also, for example, partially or totally modify or delete the data before sending. In one embodiment, the data screen appears whenever a scheduled outbound data transfer request is detected. In another embodiment, the user is enabled to define predetermined specific data strings in a database, and the data screen does not appear unless one or more of the predetermined data strings has been detected in a scheduled outbound data transfer.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a computer system in which the present invention may be implemented;

FIG. 2 is a schematic block diagram of an exemplary user computer system shown in FIG. 1;

FIG. 3 is a flow chart illustrating a high-level sequence of operation in accordance with one embodiment of the present invention;

FIG. 4 is an illustration of one implementation of an exemplary data screen function used in connection with the present invention;

FIG. 5 is a continuation of the flow chart illustrated in FIG. 3;

FIG. 6 is an illustration of some of the content of an exemplary database which may be used in a second embodiment of the present invention; and

FIG. 7 is a flow chart illustrating an exemplary sequence of operations for an embodiment using the database shown in FIG. 6.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. Also, the various methods discussed herein may be implemented within a computer network including a computer terminal, which may comprise either a workstation or a personal computer (PC) for example. In general, an implementing computer system may include computers configured with a plurality of processors in a multi-bus system in a network of similar systems.

The present disclosure illustrates several examples which enable a computer user to monitor exactly what information or data has been assembled or fetched by an outside system such as a website server of a network. In one example, a “pop-up” window which includes a data control screen, appears over a browser screen whenever there is a detection that outbound data is ready to be transmitted from the user system. For example, whenever a “cookie” is exchanged or information is assembled for outbound transmission to a central collection agency, the user has the ability to review and approve or otherwise control the flow of such information before it is sent. Although the present disclosure describes the present invention in connection with a browser application, it is understood that the functional code may also be implemented as stand-alone code or otherwise integrated into a user system in software, firmware or hardware.

In one example, code is loaded either as a stand-alone executable file, built into an operating system or as an extension to a browser application, The code will be invoked either upon connection to a network such as the Internet, or upon invocation of the browser. Whenever outbound traffic requests are made, the code will effect the capture of the outbound data package and decode it via a standard set of lookup tables for presentation to the user within a data control pop-up window. For example, a common look-up table may include an ASCII and hypertext markup language (HTML) tables, among others, to enable a translation of outbound data strings to user readable data. It is noted here that certain outbound transmissions may be exempted from the data monitoring function, for example an HTML request which originates from the user system may be excluded from the monitor process. At this point, the control falls over to the description contained in a user interface as is hereinafter described. Upon return from the user interface methodology, the code either sends the requested fields, in modified or un-modified form, per user input, or cancels delivery of the data.

The “watchdog” or monitoring function code can work above the layers of the Internet Protocol (IP) stack, or the code may interpret from multiple layers. The latter approach requires additional “hooks” into the communications software at each layer. The former implementation simply monitors packets of information and reports decoded results to the user. In the latter implementation, the code is making assumptions, analysis and interpretations regarding the existence of the information packets in context of applications before presenting decoded results to the user.

In general, when outbound data is detected, a pop-up window for example, is presented to the user and a user-readable translation of the outbound traffic flow is displayed. Contents of the data presented may include exact cookie information to be sent to a remote requester or information which is collected from the user's computer system such as machine speed, memory capacity, registered name, etc. The user is enabled to provide an input to determine what action is to be taken with regard to the scheduled outbound data. Certain default behavior may be included in the methodology. For example, the information may automatically be sent (or not be sent) after the passage of a predetermined period of time following the presentation of the data control screen. Also, the scheduled transmission may be kept on indefinite “hold” until the user provide a definite input. The user may also be allowed to modify the contents of the datastream before the data is sent such that certain fields, for example phone numbers etc., may be deleted or blanked-out before the user enables or authorizes the sending of the scheduled datastream. It is noted that the monitoring function may be customized to monitor or look at only certain types of information and not other types. For example, outbound HTTP or telenet requests may be exempted form monitoring and the user may instead choose to monitor only cookie transmissions or data gathered in response to information retrieval commands and processes conducted by software manufacturers or service providers.

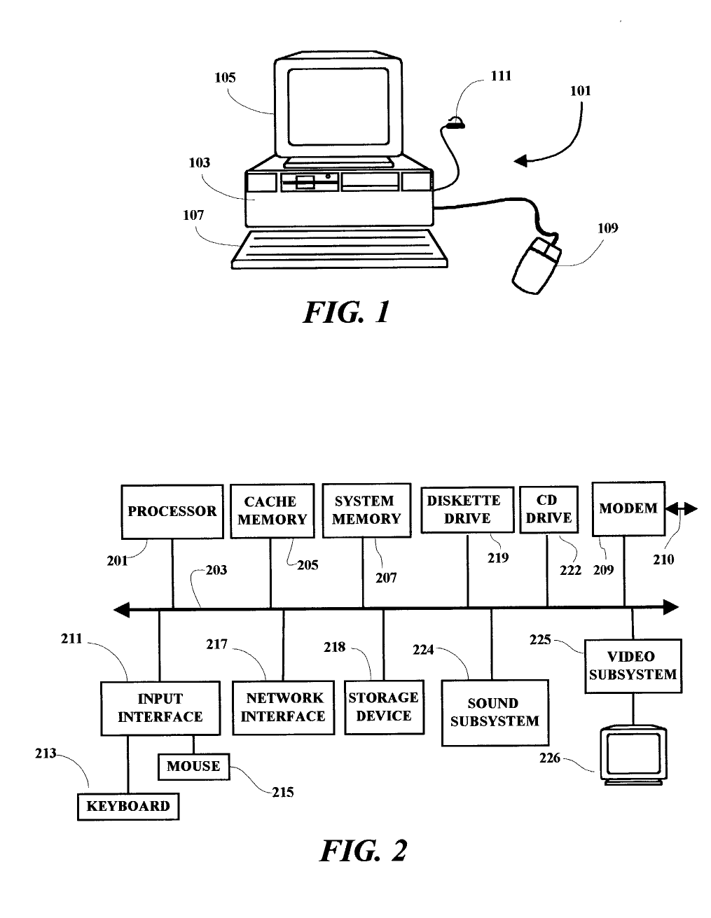

With specific reference to the illustrated examples, FIG. 1 shows a computer system or terminal 101 including a processor unit 103 which is typically arranged for housing a processor circuit along with other component devices and subsystems of the computer terminal 101. The computer terminal 101 also includes a monitor unit or display device 105, a keyboard 107 and a mouse or pointing device 109, which are all interconnected within the computer system. Also shown is a connector 111 which is arranged for connecting a modem within the computer terminal to a communication line such as a telephone line in the present example. The present invention may also be implemented in a cellular system. Other hardwire connections to cable and network systems are also generally included within the user system.

Several of the major components of the terminal 101 are illustrated in FIG. 2. A processor circuit 201 is connected to a system bus 203 which may be any host system bus. It is noted that the processing methodology disclosed herein will apply to many different bus and/or network configurations. A cache memory device 205, and a system memory unit 207 are also connected to the bus 203. A modem 209 is arranged for connection 210 to a communication line, such as a telephone line, through a connector 111 (FIG. 1). The modem 209, in the present example, selectively enables the computer terminal 101 to establish a communication link and initiate communication with network server, such as the Internet.

The system bus 203 is also connected through an input interface circuit 211 to a keyboard 213 and a mouse or pointing device 215. The bus 203 may also be coupled through a hard-wired network interface subsystem 217 to a network gateway or Internet Service Provider (ISP). A diskette drive unit 219 is also shown as being coupled to the bus 203. A video subsystem 225, which may include a graphics subsystem, is connected to a display device 226. A storage device 218, which may comprise a hard drive unit, is also coupled to the bus 203. The exemplary computer system 101 may also include a sound subsystem 224 and other non-volatile memory units such as flash memory (not shown).

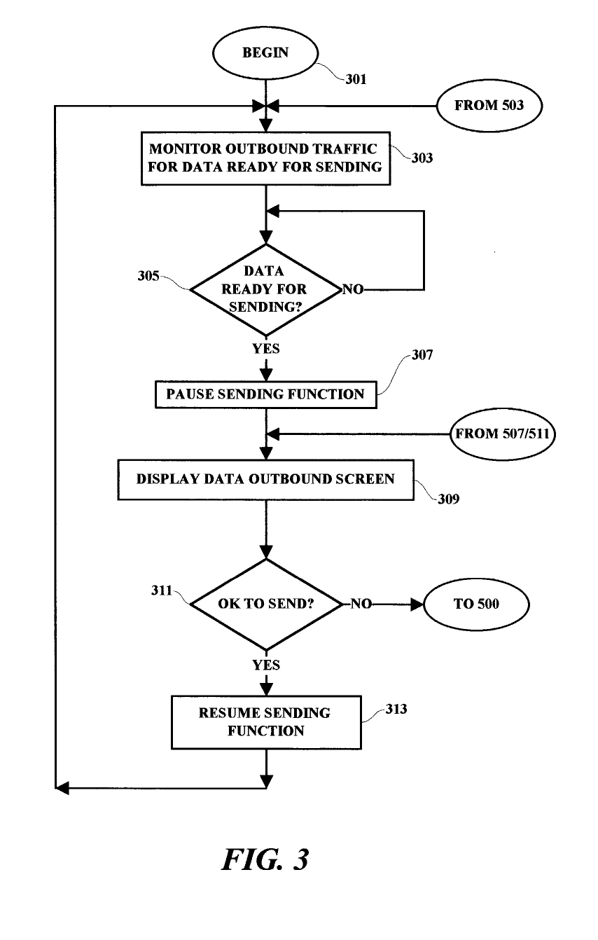

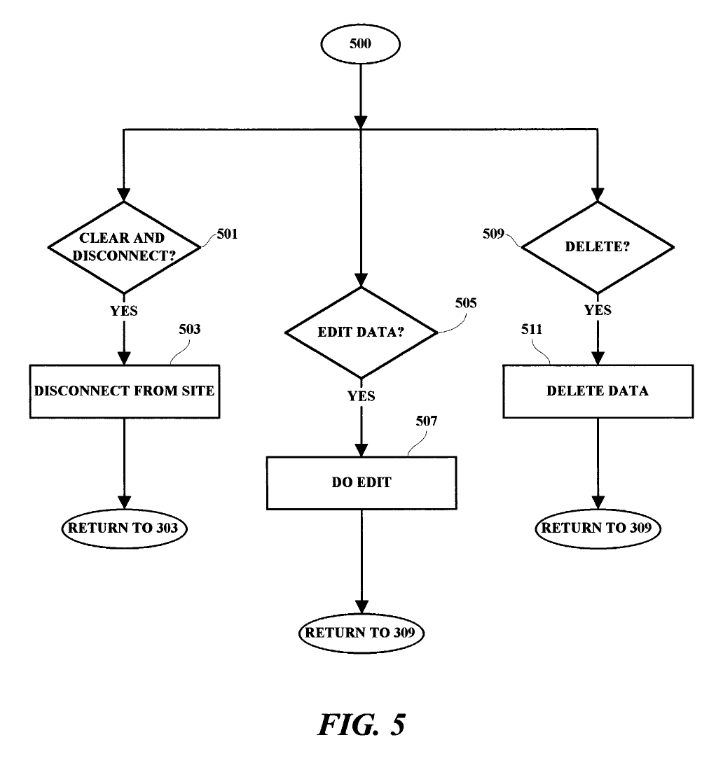

As shown in FIG. 3, the data monitoring process begins 301 when initiated, to monitor outbound traffic 303 to detect when such traffic contains data. The term “data” is used herein in its broadest sense to include, inter alia, names of fields as well as information which may be contained in the fields. For example, the term data includes not only the numbers in a social security number but also the characters or letters that comprise the identification of the field itself such as the letters “s-o-c-i-a-l” and “s-e-c-u-r-i-ty”, as well as the actual social security numerals. When the system detects that data has been assembled and is ready to be sent outside of the system 305, then the sending function is paused 307 and the data control screen or window is displayed 309 to the user. The user is then enabled to provide input to control whether or not the data is sent or modified and sent or not sent at all. If the user input indicates that the data may be sent 311, then the sending function is resumed 311 and the data are sent to the requesting outside system as the user system returns to block 303 to monitor for the next scheduled transmission which contains data. If it is determined from the user input that the displayed data is not to be sent as displayed 311, then the processing continues as illustrated in FIG. 5.

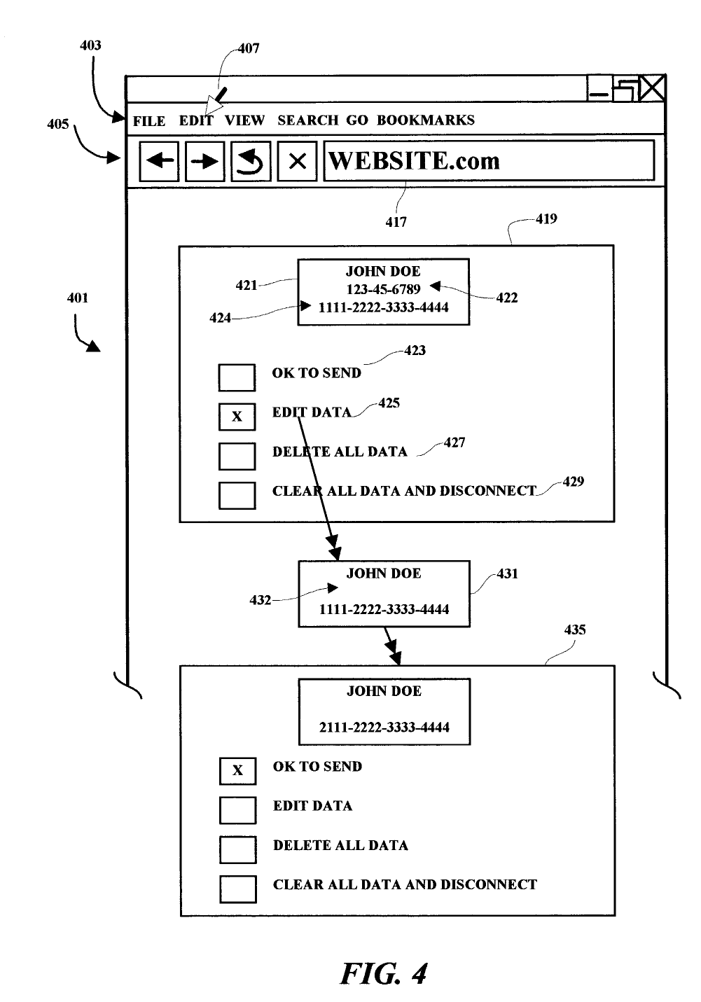

The exemplary user interface illustrated in FIG. 4 shows how a user may provide input to determine the processing of the data displayed in a data control screen. In the illustration, a browser example is used in which the user is connected to a website through the Internet. The browser screen 401 includes several functional menus 403 and 405 to help navigate through the pages at the connected website and also through the Internet to other websites. A cursor or pointing device 407 is used to aid the user in making selections from the displayed menus. As shown, the user is connected to “WEBSITE.com” 417 although the underlying content of the home page of the website is not shown in order to simplify the drawing. At the user terminal, when it has been detected that a data string or data package has been assembled and is ready to be sent from the user system, the transmission of the data is paused or suspended and a data control pop-up window 419 is presented to the user. The user is enabled to provide input to determine the destiny of the data package which is being displayed. As illustrated in the example, the data is presented in one area 421 of the window 419 and several choices are presented to the user. In the example, the user may select to send the data as presented 423 or modify the data before it is sent. If the user wished to modify the data, the user may edit the data 425, delete all data 427 or clear the data and disconnect from the website 429. Other choices may also be presented for user selection. As shown, if the user selects to modify the data by editing 425, the user is enabled to edit the data in the data block 421 as necessary or desired. For example, if the user is making a purchase from the website, the user may wish to send the credit card number 424 but not the user's social security number 422. In that example, the user will delete the social security number 422 from the data presented 432, and then indicate that the modified data is “OK TO SEND” as shown in block 435.

As shown in FIG. 5, when a user does not wish to send the “captured” data being displayed in the data control window or screen 419, the user may select exactly how the data is to be processed. In the present example, three other options are provided although more options may also be included. It is noted that the data package or string being reviewed is typically paused and held in transit buffers or a known location in memory until the user indicates a selected action to be taken. The user may select to clear the data from the transit buffers or memory storage area and disconnect from the website (or network) 501 in which case that action is accomplished 503 and the process returns to block 303 (FIG. 3) to monitor other requested data transmissions. As noted earlier, the user may select to modify the captured data by edit 505 prior to sending in which case an edit function is provided to enable the data editing 507 before the process returns to block 309 to present the data control window or screen. The user may also choose to modify the captured data by deleting the displayed data 509 in which case the data is deleted and the process returns to display 309 the data control window.

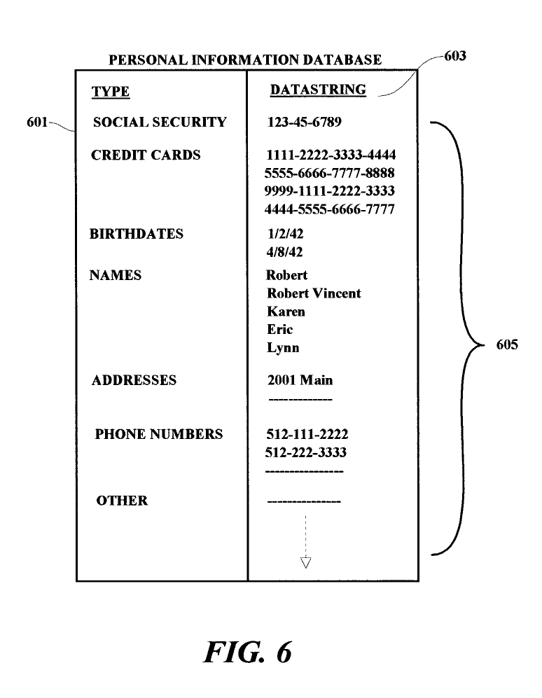

Thus far, the methodology captures any data package that is ready to send out from the user's computer system for review and control, with only a few designated exceptions (such as, for example, HTML originated in the user system). In another embodiment, the data to be monitored is much more limited to specified strings which are designated by a user. For example, a user will know the user's charge numbers, address, phone numbers, etc., which are considered by the user to be confidential or which the user does not wish to be given out without the user's specific authorization on a case by case basis. In FIG. 6, a user is enabled to create a database 601 containing the sensitive data strings 603 which may for example include names, credit card numbers, birth dates, addresses, phone numbers etc. 605, which the user wishes to safeguard from unrestricted release over the World Wide Web (WWW). The disclosed database may be updated as required when any of the sensitive information changes. Once the user has input the sensitive information, the data monitoring code will cause all captured outbound data to be compared with the data strings designated in the database, in all possible forms and/or formats, and the data control window will be generated only if there is a match between the captured data ready to be sent out of the user system and one or more of the data strings contained in the “watchdog” database. It is noted that the “matching” function will match the database data strings in all possible formats, such that, for example, the strings to be matched will include a sixteen digit credit card number including the hyphens and also a series of the sixteen numbers without the hyphens. A match in either form will trigger the data control window.

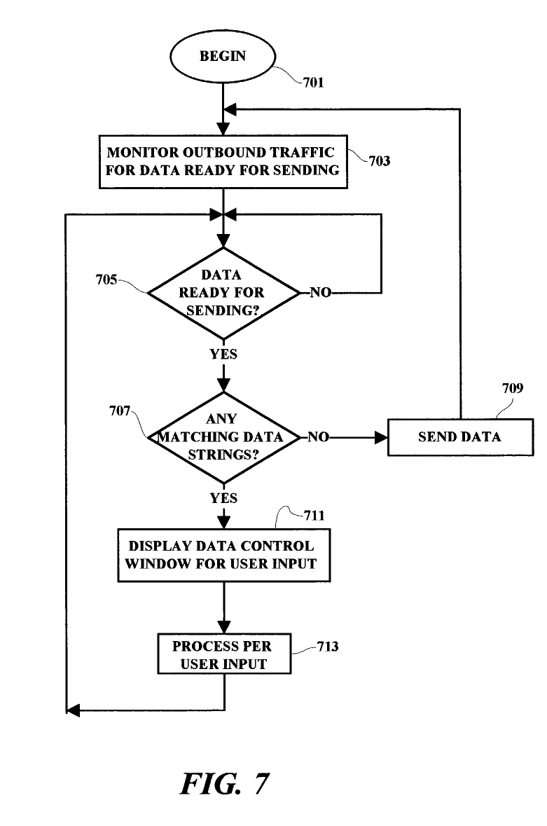

As shown in FIG. 7, the database-matching embodiment begins 701 and monitors outbound traffic 703 marked for sending out of the user system. When a data packet is ready for sending 705, a check is made to determine if there are any data stings in the data packet that match any data strings in the control database 707. If no matches are detected, the data packet is automatically sent 709 without user intervention. However, when one or more matches are detected 707, the data flow is paused or suspended and the data control window (such as window 419 in FIG. 4) is presented to enable the user to select what action to take next. The user's input with regard to the captured data is processed 713 and the methodology returns to block 705 to await the next data packet ready for sending. It is noted that the database matching function may be performed on data after it is determined that a data package is ready for sending as shown in FIG. 7, or it may be performed on a continuing basis as data are assembled in transit buffers or memory associated with the communication function.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for controlling outbound data from a computer system, said method comprising:
determining when said outbound data are about to be transmitted from said computer system, said determining being accomplished independently of an application requesting said outbound data;
displaying said outbound data on a display device; and
enabling a user to modify said outbound data.

2. The method as set forth in claim 1 wherein said computer system comprises an individual user computer, said user computer being arranged for connection in a network including other computer systems, said outbound data being requested by one or more of said other computer systems.

3. The method as set forth in claim 1 wherein said computer system comprises a user computer running a browser application, said browser application being operable for generating browser application screens, said displaying being accomplished by generating a data control window overlaying said browser application screens.

4. The method as set forth in claim 1 and further including:
pausing a sending of said outbound data whenever said outbound data are about to be transmitted; and
resuming said sending after said enabling in response to a user input.

5. The method as set forth in claim 1 and further including:
pausing a sending of said outbound data whenever said outbound data are about to be transmitted; and
resuming said sending after said enabling in response to a passage of a predetermined period of time following said pausing.

6. The method as set forth in claim 1 and further including:
pausing a sending of said outbound data whenever said outbound data are about to be transmitted; and
canceling said sending if no user input has been provided within a predetermined period of time after said pausing.

7. The method as set forth in claim 1 wherein said outbound data comprise only data which matches data contained in a sensitive data database.

8. The method as set forth in claim 7 and further including enabling a creation and modification of said sensitive data database by said user.

9. The method as set forth in claim 1 wherein said modifying includes editing said outbound data.

10. The method as set forth in claim 1 wherein said modifying includes deleting at least a portion of said outbound data.

11. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable controlling of outbound data from said computer system, said program signals being selectively operable to accomplish the steps of:
determining when said outbound data are about to be transmitted from said computer system, said determining being accomplished independently of an application requesting said outbound data;
displaying said outbound data on a display device; and
enabling a user to modify said outbound data.

12. The medium as set forth in claim 11 wherein said computer system comprises an individual user computer, said user computer being arranged for connection in a network including other computer systems, said outbound data being requested by one or more of said other computer systems.

13. The medium as set forth in claim 11 wherein said computer system comprises a user computer running a browser application, said browser application being operable for generating browser application screens, said displaying being accomplished by generating a data control window overlaying said browser application screens.

14. The medium as set forth in claim 11 wherein said program signals are further effective for:
pausing a sending of said outbound data whenever said outbound data are about to be transmitted; and
resuming said sending after said enabling in response to a user input.

15. The medium as set forth in claim 11 wherein said program signals are further effective for:
pausing a sending of said outbound data whenever said outbound data are about to be transmitted; and
resuming said sending after said enabling in response to a passage of a predetermined period of time following said pausing.

16. The medium as set forth in claim 11 wherein said program signals are further effective for:
pausing a sending of said outbound data whenever said outbound data are about to be transmitted; and
canceling said sending if no user input has been provided within a predetermined period of time after said pausing.

17. The medium as set forth in claim 11 wherein said outbound data comprise only data which matches data contained in a sensitive data database.

18. The medium as set forth in claim 17 and further including enabling a creation and modification of said sensitive data database by said user.

19. The medium as set forth in claim 11 wherein said modifying includes editing said outbound data.

20. The medium as set forth in claim 11 wherein said modifying includes deleting at least a portion of said outbound data.

21. A computer system comprising:
a system bus;
a CPU device connected to said system bus;
a memory device connected to said system bus;
an input device connected to said system bus, said input device being arranged to enable user input to said computer system;
a user display device connected to said system bus; and
output data control means arranged within said computer system for enabling user control of outbound data from said computer system, said outbound data control means being selectively operable for determining when said outbound data are about to be transmitted from said computer system, said determining being accomplished independently of an application requesting said outbound data, displaying said outbound data on said user display device, and enabling a user through said input device to modify said outbound data.
